(19) United States
(12) Patent Application Publication
(10) Pub. No.: US 2005/0243023 A1
(43) Pub. Date: Nov. 3, 2005

(54) Color filter integrated with sensor array for flat panel display

(76) Inventors: Damoder Reddy, Los Gatos, CA (US); W. Edward Naugler JR., Cedar Park, TX (US)

Correspondence Address: DORSEY & WHITNEY LLP, 555 CALIFORNIA STREET, SUITE 1000, SUITE 1000, SAN FRANCISCO, CA, 94104, US

(21) Appl. No.: 11/100,668

(22) Filed: Apr. 6, 2005

Related U.S. Application Data
(60) Provisional application No. 60/559,729, filed on Apr. 6, 2004.

(51) Int. Cl. G09G 3/16

(52) U.S. Cl. 345/48

(57) ABSTRACT

The embodiments of the present invention provide a color filter integrated with a sensor array and methods of fabricating the same. By integrating the sensor array with the color filter, the overall cost of the display is reduced. Moreover, the integration allows the sensor array to be used like a touch screen for data input. As a further benefit, the integration allows the color filter to serve as a light shield thus eliminating the need for a separate light shield for the sensor array.

### CROSS REFERENCE TO RELATED APPLICATIONS

The present application claims priority to U.S. Provisional Patent Application No. 60/559,729 entitled “Optical Sensory System Integrated with a Flat Panel Display Color Filter,” filed on Apr. 6, 2004, the entire disclosure of which is incorporated herein by reference.

The present application is related to commonly assigned US patent application Attorney Docket Number 186350/US/2/RMA/JJZ (474125-37), entitled “Low Power Circuits for Active Matrix Emissive Displays and Methods Of Operating the Same,” filed Apr. 6, 2005, commonly assigned U.S. patent application Ser. No. 10/872,344, entitled “Method and Apparatus for Controlling an Active Matrix Display,” filed Jun. 17, 2004, and commonly assigned U.S. patent application Ser. No. 10/841,198 entitled “Method and Apparatus for Controlling Pixel Emission,” filed May 6, 2004, each of which is incorporated herein by reference.

### FIELD OF THE INVENTION

The present invention relates to flat panel displays and particularly to a color filter integrated with a sensor array for a flat panel display.

### BACKGROUND OF THE INVENTION

Liquid crystal dispays (LCD) have been implemented on or interfaced with almost all types of digital devices, from watches to computers to projection TVs. An LCD typically includes pixels each having a Liquid Crystal Cell (LCC). An image in the LCD is formed by applying an electric field to alter the chemical properties of each LCC in the display in order to change the LCC's light transmission or absorption properties, so that the LCC modifies the image produced by a backlight as requested by a controller. Though the end output may be in color, the LCCs themselves are monochrome. The colors are added through a filtering process. Modern laptop computer displays can produce 16,521,216 simultaneous colors at a resolution of 800×600. The number of simultaneous colors or the resolution varies from display to display.

In a typical LCD, a light ray from a light source passes through a light polarizer, which polarizes the light so that it can be acted upon by an LCC matrix. The polarized light passes through the LCC matrix, and a second polarizer (often called the analyzer), and each pixel in the LCC matrix acts as a shutter to allow the light to be transmitted, to block the light, or to reduce the brightness of the light to a certain extent. In a color display, each pixel in the LCC matrix includes a number, such as three, subpixels that operate under principles of additive light in conjunction with color filters to produce an apparent color. After the light passes through the LCC matrix, it passes through a color filter or a set of color filters made of, for example, dyed glass. In a typical Red-Green-Blue (RGB) display, the color filter is integrated into an upper glass, which is colored microscopically to provide red, green, and blue filter elements over respective ones of the three subpixels in each pixel. Each color element blocks all wavelengths of light except those within the range of that color element. The areas in between the color filter elements may be printed black to increase contrast. Combinations of various light levels passing through these color filter elements associated with a pixel can produce most of the visible spectral colors.

Color filters have been used in active matrix liquid crystal displays (AMLCDs) for many years. In an AMLCD, each LCC is stimulated individually by a dedicated transistor or diode. Existing AMLCD technologies include Thin Film Transistor (TFT) and metal-insulator-metal (MIM). Color filters have also been used in relatively new organic light emitting diode (OLED) displays. For example, eMagin Corporation (Hopewell Junction, N.J.) developed a full color OLED micro-display using a particular white OLED and a particular set of color filter for the red, green, and blue primaries.

### SUMMARY OF THE INVENTION

In some displays, such as those described in related applications cited above, sensors are included to provide better control of pixel luminance, improve image quality, reduce power consumption, increase display life, and lower manufacturing costs. Each sensor is associated with a respective pixel or subpixel in a display and is positioned to receive a portion of the light emitted from the pixel or subpixel. Each sensor also has an associated electrical parameter dependent on a level of light emissions received from the respective pixel so that an electrical feedback dependent on the received level of light emissions can be used to control the luminance of the associated pixel. The sensors for a display are arranged in a sensor array that is aligned with the pixels of the display.

The embodiments of the present invention provide a color filter integrated with a sensor array and methods of fabricating the same. By integrating the sensor array with the color filter, the overall cost of the display is further reduced. Moreover, the integration allows the sensor array to be used like a touch screen for data input. Conventionally, the addition of a touch screen can double the cost of a display. If the touch feature is integrated with a color filter, however, significant cost savings can be realized. As a further benefit, the integration allows the color filter to serve as a light shield thus eliminating the need for a separate light shield for the sensor array. The light shield is used to reduce the amount of ambient light striking the sensor array.

In one embodiment, the color filter comprises a plurality of color filter elements formed on a substrate and organized in groups, each color element in a group being associated with a different color, and a first array of sensors aligned with the color filter elements and formed on the substrate. The color filter elements are formed on a transparent substrate and are covered by a first layer of transparent material. The first array of sensors is formed over the first layer of transparent material. The color filter may further comprise a first group of conductive lines formed over the first layer of transparent material and in contact with respective rows of sensors. In an embodiment where the display is used as a touch screen, the color filter may further comprise a second array of sensors over the first array of sensors and aligned with the first array of sensors. The second array of sensors are interconnected by conductive lines running orthogonal to conductive lines interconnecting the first array of sensors.

The embodiments of the present invention also provide a method for fabricating a color filter integrated with a sensor array. The method comprises: forming a plurality of color filter elements on a transparent substrates; covering the plurality of color filter elements with a first layer of a transparent material; forming a first array of sensors on the first layer of transparent material; and forming on the first layer of transparent material a first group of conductive lines each connected to a row of sensors. In an embodiment where the display is a passive matrix display, the method may further comprise forming on the first layer of transparent material a second group of conductive lines each connected to a row of sensors. In an alternative embodiment where the display is an active matrix display, the method further comprises covering the plurality of sensors and the first layer of transparent material with a second layer of a transparent material and forming on the second layer of transparent material a second group of conductive lines running in a direction orthogonal to the first group of conductive lines. In yet another alternative embodiment where the display is used as a touch screen, the method further comprises covering the plurality of sensors and the first layer of transparent material with a second layer of a transparent material and forming on the second layer of transparent material a second array of sensors.

The embodiments of the present invention also provide a display comprising a display component comprising a plurality of subpixels organized in groups and formed on a first substrate, each subpixel in a group being associated with a different color, and a filter component. The filter component comprises a plurality of color filter elements organized in groups and formed on a second substrate, each group of color filter elements corresponding to a respective group of subpixels in the display component, each color element in a group being associated with a different color, and an array of sensors formed on the second substrate and aligned with the plurality of subpixels and with the plurality of color filter elements. Each sensor has an associated electrical parameter dependent on a level of light emissions received from a respective subpixel thereby an electrical feedback parameter or signal dependent on the received level of light emissions is used to control the luminance of the respective subpixel.

### BRIEF DESCRIPTION OF THE DRAWINGS

FIG. 1A is a block diagram of a display employing a sensor array according to one embodiment of the present invention.

FIG. 1B is a block diagram of a display having a display component and a color filter component formed on two separate substrates according to one embodiment of the present invention.

FIG. 2 is a circuit schematic of an exemplary implementation of the display in FIG. 1.

FIG. 3 is a diagram of a display component and a color filter component in an active matrix display according to one embodiment of the present invention.

FIG. 4 is a diagram of a display component and a color filter component in passive display according to one embodiment of the present invention.

FIG. 5 is a diagram of a display component and a color filter component in a display having a touch screen function according to one embodiment of the present invention.

FIG. 6A is a block diagram illustrating a cross section of a portion of a passive display according to one embodiment of the present invention.

FIG. 6B is a block diagram illustrating a cross section of a portion of an active matrix display according to one embodiment of the present invention.

### DETAILED DESCRIPTION OF THE EMBODIMENTS

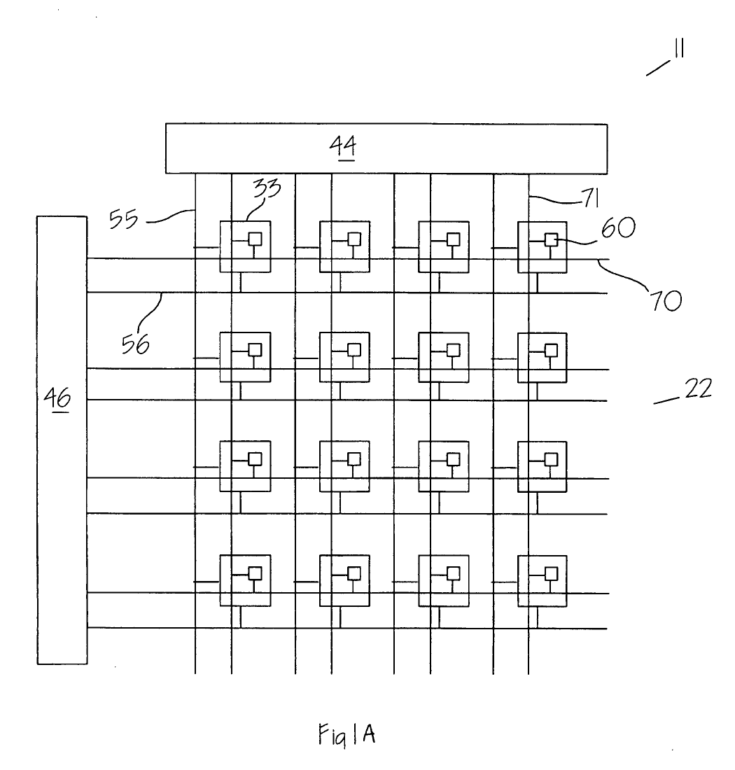

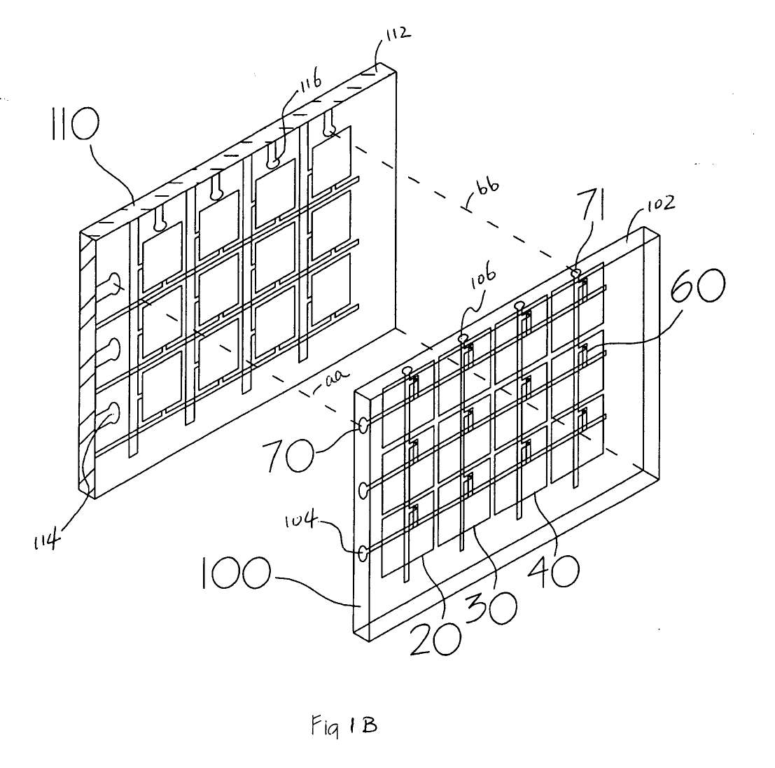

Embodiments of the present invention provide a color filter integrated with a sensor array and methods of fabricating the same. FIG. 1A is a block diagram of an active matrix emissive display 11 employing a sensor array 22, according to one embodiment of the present invention. As shown in FIG. 1A, display 11 comprises a plurality of pixels each coupled to a column control circuit 44 via a column line 55 and to a row control circuit 46 via a row line 56. Sensor array 22 comprises a plurality of sensors 60 each coupled to the row control circuit 46 via a sensor row line 70 and to the column control circuit 44 via a sensor column line 71.

In one embodiment, each sensor 60 is associated with a respective pixel 33 and is positioned to receive a portion of the light emitted from the pixel. Pixels may generally be square, as shown in FIG. 1A, but can be any shape such as rectangular, round, oval, hexagonal, polygonal, or any other shape. If display 11 is a color display, pixel 33 can also be subpixels organized in groups, each group corresponding to a pixel. The subpixels in a group should include a number (e.g., 3) of subpixels each occupying a portion of the area designated for the corresponding pixel. For example, if each pixel is in the shape of a square, the subpixels are generally as high as the pixel, but only a fraction (e.g., ⅓) of the width of the square. Subpixels may be identically sized or shaped, or they may have different sizes and shapes. Each subpixel may include the same circuit elements as pixel 33 and the sub-pixels in a display can be interconnected with each other and to the column and row control circuits 44 and 46 just as the pixels 33 shown in FIG. 1A. In a color display, the sensor array 22 should have a sensor 60 associated with each subpixel. In the following discussions, the reference of a pixel can mean both a pixel or subpixel.

Each sensor 60 may include a sensor material having an associated electrical parameter dependent on a level of light or photon emissions received from the respective pixel 33 so that an electrical feedback parameter or signal dependent on the received level of light emissions can be provided to column control circuit 44 via the sensor column line 71 coupled to the sensor 60. Each sensor 60 may also include circuit elements in addition to the sensor material. For example, in an active matrix display, each sensor 60 may include an isolation transistor for preventing cross talk among the sensors, as discussed in more detail below.

The row control circuit 46 is configured to activate a selected row of sensors 60 by, for example, raising a voltage on a selected sensor row line 70, which couples the selected row of sensors to the row control circuit 46. The column control circuit 44 is configured to detect changes in the electrical parameters associated with the selected row of sensors and to control the luminance of the corresponding row of pixels 33 based on the changes in the electrical parameters. This way, the luminance of each pixel can be controlled at a specified level based on feedback from the sensor array. In other embodiments, the sensors 60 may be used for purposes other than or in addition to feedback control of the pixel luminance, and the sensor array may include more or less sensors than the pixels or subpixels in a display.

The sensor array and the pixels can be formed on a same substrate, or, they can be formed on a plurality of different substrates. In one embodiment, display 11 is a color display comprising a color filter component 100 and a display component 110, as illustrated in FIG. 1B. The display component 110 comprises subpixels 33, the column control circuit 44, the row control circuit 46, the column lines 55, and the row lines 56 formed on a first substrate 112. The color filter component 100 comprises the sensors 60, the sensor row lines 70, and the sensor column lines 71 formed on a second substrate 102, on which a plurality of color filter elements are also formed. The color filter elements comprises color filter elements organized in groups each having a number (e.g., 3) of different color filter elements, such as a RED filter element 20, a GREEN filter element 30, and a BLUE filter element 40.

When the two components are put together to form display 11, electrical contact pads or pins 114 on display component 110 are mated with electrical contact pads 104 on filter/sensor plate 100, as indicated by the dotted line aa, in order to connect the sensor row lines 70 to the row control circuit 46. Likewise, electrical contact pads or pins 116 on display component 110 are mated with electrical contact pads 106 on filter/sensor plate 100, as indicated by the dotted line bb, in order to connect the sensor column lines 71 to the column control circuit 44. It is understood that display component 110 can be one of any type of displays including but not limited to LCDs, electroluminescent displays, plasma displays, LEDs, OLED based displays, micro electrical mechanical systems (MEMS) based displays, such as the Digital Light projectors, and the like. For ease of illustration, only one set of column lines 55 and one set of row lines 56 for the display component 100 are shown in FIG. 1B. In practice, there may be more than one set of column lines and/or more than one set of row lines associated with the display component 110. For example, in an OLED-based active matrix emissive display, as discussed below, display component 110 may comprise another set of row lines connecting each pixel 33 to a respective one of the contact pads 114.

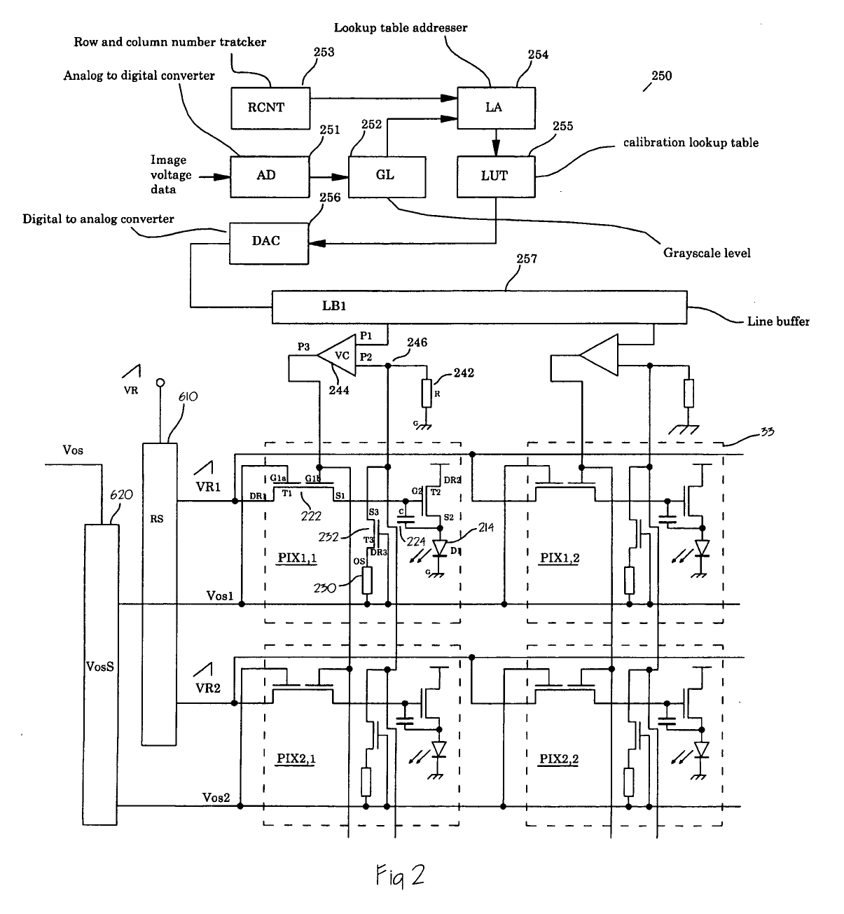

FIG. 2 illustrates one implementation of one embodiment of display 11. For ease of illustration, the color filter elements are not shown in FIG. 2. As shown in FIG. 2, display 11 comprises a plurality of pixels 33 arranged in rows and columns, with pixels PIX1,1, PIX1,2, etc., in row 1, pixels PIX2,1, PIX2,2, etc., in row 2, and so on for the other rows in the display. Each pixel 33 comprises a transistor 212, a light-emitting device 214, a switching device 222, and a capacitor 224. FIG. 2 also shows a sensor array comprising a plurality of optical sensors (OS) 230 arranged in rows and columns, each OS 230 corresponding to a pixel.

Each OS 230 can be any suitable sensor having a measurable property, such as a resistance, capacitance, inductance, or the like parameter, property, or characteristic, dependent on received emissions. An example of OS 230 is a photosensitive resistor whose resistance varies with an incident photon flux. Each OS 230 may also comprise a capacitor coupled to the photosensitive resistor in parallel. As another example, each OS 230 is a calibrated photon flux integrator, such as the one disclosed in commonly assigned U.S. patent application Ser. No. 11/016,372 entitled “Active-Matrix Display and Pixel Structure for Feedback Stabilized Flat Panel Display,” filed on Dec. 17, 2004, which application is incorporated herein by reference in its entirety. Thus, each OS 230 may include at least one type of material that has one or more electrical properties changing according to the intensity of radiation falling or impinging on a surface of the material. Such materials include but are not limited to amorphous silicon (a-Si), cadmium selenide (CdSe), silicon (Si), and Selenium (Se). Other radiation-sensitive sensors may also or alternatively be used including, but not limited to, optical diodes, and/or optical transistors.

Optionally, an isolation device 232 such as an isolation transistor may be provided to prevent possible cross talk among OS 230. Isolation transistor 232 can be any type of transistor having first and second terminals and a control terminal, with conductivity between the first and second terminals controllable by a control voltage applied to the control terminal. In one embodiment, isolation transistor 232 is a TFT with the first terminal being a drain DR3, the second terminal being a source S3, and the control terminal being a gate G3. The isolation transistor 232 is serially coupled with OS 230, with the source S3 or drain DR3 connected to one terminal of OS 230 and the control terminal of G3 connected to an opposite terminal of OS 230. Either OS 230 itself or the combination of OS 230 and isolation transistor 232 may be included in sensor 60.

Light-emitting device 214 may generally be any light-emitting device known in the art that produces radiation such as light emissions in response to an electrical measure such as an electrical current through the device or an electrical voltage across the device. Examples of light-emitting device 514 include but are not limited to light emitting diodes (LED) and organic light emitting diodes (OLED) that emit light at any wavelength or a plurality of wavelengths. Other light-emitting devices may be used including electroluminescent cells, inorganic light emitting diodes, and those used in vacuum florescent displays, field emission displays and plasma displays. In one embodiment, an OLED is used as the light-emitting device 214.

Light-emitting device 214 is sometimes referred to as an OLED 214 hereinafter. But it will be appreciated that the invention is not limited to using an OLED as the light-emitting device 214. Furthermore, although the invention is sometimes described relative to a flat panel display, it will be appreciated that many aspects of the embodiments described herein are applicable to a display that is not flat or built as a panel.

Transistor 212 can be any type of transistor having a first terminal, a second terminal, and a control terminal, with the current between the first and second terminals dependent on a control voltage applied to the control terminal. In one embodiment, transistor 212 is a TFT with the first terminal being a drain D2, the second terminal being a source S2, and the control terminal being a gate G2. Transistor 212 and light-emitting device 214 are serially coupled between a power supply V_{DD} and ground, with the first terminal of transistor 212 connected to V_{DD}, the second terminal of transistor 212 connected to the light-emitting device 214, and the control terminal connected to switching device 222.

In one embodiment, switching device 222 has a first control terminal G1a, a second control terminal G1b, an input DR1, and an output S2. As a non-limiting example, switching device 222 can be a double-gated TFT, that is, a TFT with a single channel but two gates G1a and G1b. The double gates act like an AND function in logic, because for the TFT 222 to conduct, logic highs need to be simultaneously applied to both gates. Although a double-gated TFT is preferred, any switching device implementing the AND function in logic is suitable for use as the switching device 222. For example, two serially coupled TFTs or other types of transistors may be used as the switching device 222. Use of a double-gated TFT or other device implementing the AND function in logic as the switching device 222 helps to reduce cross talk between pixels, and so if some cross-talk can be tolerated only a single-gated TFT or other device may be required.

Display 11 further comprises row lines, VR1, VR2, etc and a ramp selector (RS) 610 configured to receive a ramp voltage VR and to select one of row lines, VR1, VR2, etc., to output the ramp voltage VR. Each of row lines VR1, VR2, etc., is connected to drain DR1 of switching device 222 in each of a corresponding row of pixels 200. Circuit 100 further comprises sensor row lines, Vos1, Vos2, etc., and a line selector (VosS) configured to receive a line select voltage Vos and to select one of sensor row lines, Vos1, Vos2, etc., to output the line select voltage Vos. Each of lines Vos1, Vos2, etc., is connected to the OS 230 and to gate G1a of switching device 222 in each of a corresponding row of pixels 33. In embodiments wherein sensor array 22 is fabricated on a different substrate from the substrate on which the pixels are formed, as shown in FIG. 1B, another set or row lines (not shown) are provided to allow gate G1a to be connected to contact pads 114 and thus to the sensor row lines Vos1, Vos2, etc., when the two substrates are mated together. RS 610 and VosS 620 are part of the row control circuit 46 and can be implemented using shift registers.

FIG. 2 also shows a part of the column control circuit 44, a data input unit 250, a plurality of comparator 244 each associated with a column of pixels, and a plurality of voltage divider resistor 242 each associated with a comparator 244. Each voltage divider resistor 242 is coupled between each of a column of sensors and ground. Each comparator 224 has a first input P1 coupled to the data input unit 250, a second input P2 coupled to a circuit node 246 between each sensor 60 in the corresponding column and the voltage divider resistor 242, and an output P3 coupled to control terminal G1b switching device 222.

FIG. 2 further shows the data input unit 250 as comprising an analog to digital converter (A/D) 251 configured to convert a received image voltage data to a corresponding digital value, an optional grayscale level calculator (GL) 252 coupled to the A/D 251 and configured to generate a grayscale level corresponding to the digital value, a row and column tracker unit (RCNT) 253 configured to generate a line number and column number for the image voltage data, a calibration look-up table addresser (LA) 254 coupled to the RCNT 253 and configured to output an address in the display 11 corresponding to the line number and column number, and a look-up table (LUT) 255 coupled to the GL 252 and the LA 254. Data input unit 250 further comprises a digital to analog converter (DAC) 256 coupled to the LUT 255 and a line buffer (LB) 257 coupled to the DAC 256.

In one embodiment, LUT 255 stores calibration data obtained during a calibration process for calibrating, against a light source having a known luminance, each sensor in the display circuit 100. Related patent application Ser. No. 10/872,344 and application Ser. No. 10/841,198, supra, describe an exemplary calibration process, which application and description is incorporated herein by reference. The calibration process results in a voltage divider voltage level at circuit node 246 in each pixel for each grayscale level. As a non-limiting example, an 8-bit grayscale has 0-256 levels of luminance with the 255^{th} level being at a chosen level, such as 300 nits for a Television screen. The luminance level for each of the remaining 255 levels is assigned according to the logarithmic response of the human eye. The zero level corresponds to no (or a minimal) emission. Each value of brightness will produce a specific voltage on the circuit node 246 between OS 230 and voltage divider resistor 242. These voltage values are stored in lookup table LUT as the calibration data. Thus, based on the address provided by LA 254 and the gray scale level provided by GL 252, the LUT 255 generates a calibrated voltage from the stored calibration data and provides the calibrated voltage to DAC 256, which converts the calibrated voltage into an analog voltage value and downloads the analog voltage value to LB 257. LB 257 provides the analog voltage value as a reference voltage to input P1 of comparator 244 associated with the column corresponding to the address.

Initially, all of lines Vos1, Vos2, etc., are at zero or even a negative voltage depending on specific application. So the switching device 222 in each pixel 33 is off no matter what the output P3 of the comparator 244 is. Also, isolation transistor 232 in each pixel is off so that no sensor is connected to P2 of the comparator 244. Also note that the voltage on P2 of voltage comparator 244 is zero (or at ground) because there is no current flowing through the resistor 242, which is connected to ground. In one embodiment, comparator 244 is a voltage comparator that compares the voltage levels at its two inputs P1 and P2 and generates at its output P3 a positive supply rail (e.g., +10 volts) when P1 is larger than P2 and a negative supply rail (e.g., 0 volts) when P1 is equal of less than P2. The positive supply rail corresponds to a logic high for the switching device 222 while negative supply rail corresponds to a logic low for the switching device 222. Initially, before OLED 214 emits light, OS 230 has a maximum resistance to current flow; and voltage on input pin P2 of VC 244 is minimum because the resistance R of voltage divider resistor 242 is small compared to the resistance of OS 230. So, as the reference voltages for the first row (row 1), which includes pixels PIX1,1, PIX1,2, etc., are written to line buffer 257, all of the gates G1b in the pixels are opened because input P1 in each comparator 244 is supplied with a reference voltage while input P2 in each comparator 244 is grounded, causing comparator 244 to generate the positive supply rail at output P3.

Image data voltages for row 1 of the display 11 are sent to the A/D converter 630 serially and each is converted to a reference voltage and stored in LB 257 until LB1 stores the reference voltages for every pixel in the row. At about the same time, shift register Vos 620 sends the Vos voltage (e.g., +10 volts) to line Vos1, turning on gate G1b of each switching device 224 in row 1, and thus, the switching devices 222 themselves (since gate G1a is already on). The voltage Vos on line Vos1 is also applied to OS 230 and to the gate G3 of transistor 232 in each of the first row of pixels, causing transistor 232 to conduct and current to flow through OS 230. Also at about the same time, shift register RS 610 sends the ramp voltage VR (e.g., from 0 to 10 volts) to line VR1, which ramp voltage is applied to storage capacitor 224 and to the gate G2 of transistor 212 in each pixel in row 1 because switching device 222 is conducting. As the voltage on line VR1 is ramped up, the capacitor 224 is increasingly charged, the current through transistor 212 and OLED 214 in each of the first row of pixels increases, and the light emission from the OLED also increases. The increasing light emission from the OLED 214 in each pixel in row 1 falls on OS 230 associated with the pixel and causes the resistance associated with the OS 230 to decrease, and thus, the voltage across resistor 242 or the voltage at input P2 of comparator 244 to increase.

This continues in each pixel in row 1 as the OLED 214 in the pixel ramps up in luminance with the increase of ramp voltage VR until the OLED 214 reaches the desired luminance for the pixel and the voltage at input P2 is equal to the reference voltage at input P1 of comparator 244. In response, output P3 of comparator 244 changes from the positive supply rail to the negative supply rail, turning off gate G1b of switching device 222 in the pixel, and thus, the switching device itself. With the switching device 222 turned off, further increase in VR is not applied to gate G of transistor 212 in the pixel, and the voltage between gate G2 and the second terminal S2 of transistor 212 is held constant by capacitor 224 in the pixel. Therefore, the emission level from OLED 214 in the pixel is frozen or fixed at the desired level as determined by the calibrated reference voltage placed on pin, P1 of the voltage comparator 244 associated with the pixel.

The duration of time that the ramp voltage VR1 takes to increase to its full value is called the line address time. In a display having 120 lines and running at 60 frames per second, the line address time is approximately 33 micro seconds or shorter. Therefore, all the pixels in the first row are at their respective desired emission levels by the end of the line address time. And this completes the writing of row 1 in the display 11. After row 1 is written, both horizontal shift registers, VosS 620 and RS 610 turn off lines VR1 and Vos1, respectively, causing switching device 222 and isolation transistor 232 to be turned off, thereby, locking the voltage on the storage capacitor 224 and isolating the OS 230 in row 1 from the voltage comparators 244 associated with each column. When this happens, the voltage on pin P2 of each comparator 244 goes to ground as no current flows in resistor R, causing the output P3 of the voltage comparator 244 to go back to the positive supply rail, turning gate G1b of switching device 222 in each related pixel back on, ready for the writing of the second row of pixels in display 11. It is understood that the above example of how a display is operated is an example and that there are many ways to implement both active and passive types of displays and that any of them will work with the invention including but not limited to LCDs, electroluminescent, Plasma, LED, OLED, MEMS such as the Digital Light projector, to name a few.

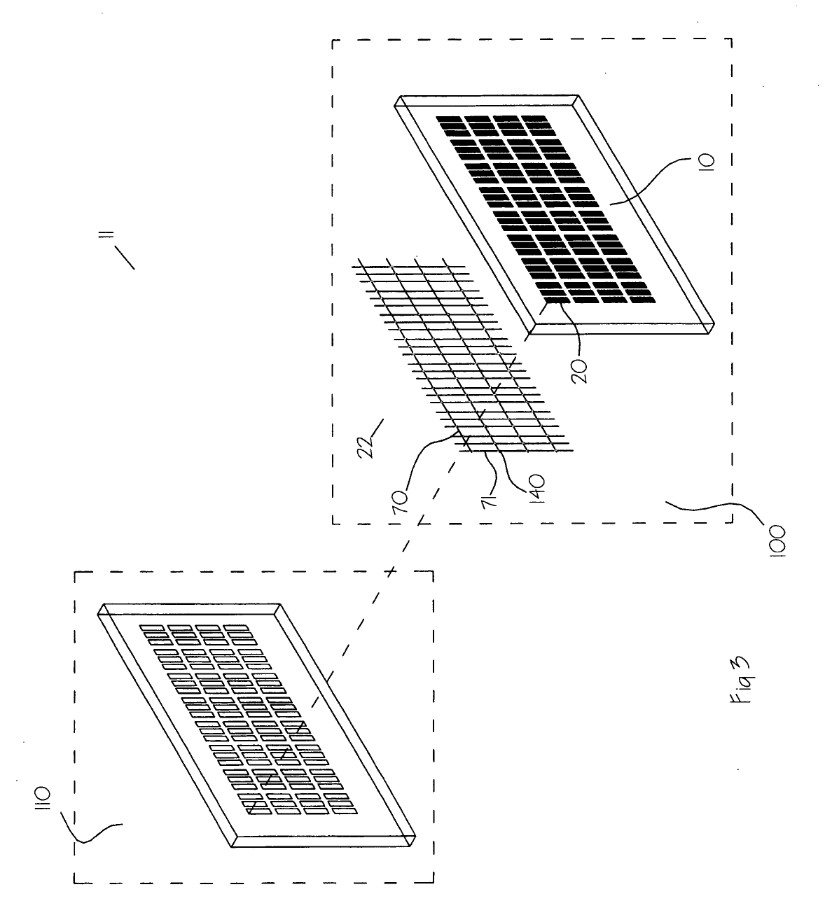

As discussed above, the sensor array 22, including the plurality of sensors 60, the sensor row lines 70, and the sensor column lines 71, can be formed on a different substrate from the substrate on which the pixels, the row lines 7, and the column lines 5 are formed. As shown in FIG. 3, in one embodiment, display 11 is a color display and comprises a color filter component 100 including the sensor array 22 integrated with a plurality of color filter elements 20, 30, and 40 formed on a transparent substrate 10, and a display component 110 including a plurality of subpixels 120 in groups of three. The plurality of color filter elements 20, 30 and 40 are also organized in groups of three. Each group of color filter elements corresponds to a group of 3 subpixels and includes color filter elements associated with three different colors, such as red, green, and blue, for the respective ones of the subpixels in the group of subpixels. The correspondence is illustrated by the dashed line, which extends from a subpixel 120 in the display component 110 to a sensor 60 in the sensor array 9 and further to a color element 20 in the color filter 9. The sensors 60 in the sensor array 22 are connected to respective sensor row lines 70 and sensor column lines 71.

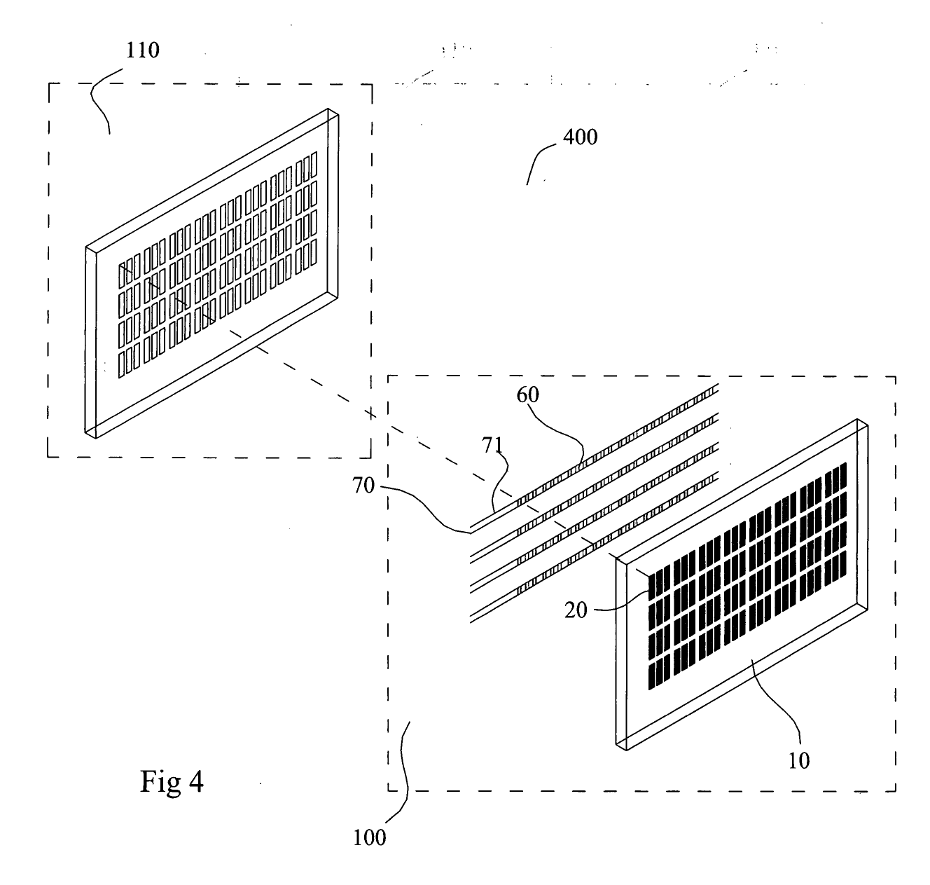

With reference to FIG. 3, embodiments of the invention provide the sensor row lines 70 and sensor column lines 71 as running in directions orthogonal to each other. This is a proper arrangement for an active matrix display but is not necessary for other applications. For example, as shown in FIG. 4, in a passive display 400, where each sensor 60 in the sensor array 22 do not need to be individually addressed, lines 70 and 71 may both be row lines or column lines running parallel to each other. This is a relatively simple sensory array where the sensors 60 are optical resistors strung ladder like between conductive lines 70 and 71. In this embodiment the sensory array 22 is used to measure the light output from the subpixels 120 before the light passes through the color filter 9. The advantage of this is that the sensors are exposed to the full spectrum of the pixel light emission, and thus, give maximum resistance value changes in response pixel light emission changes.

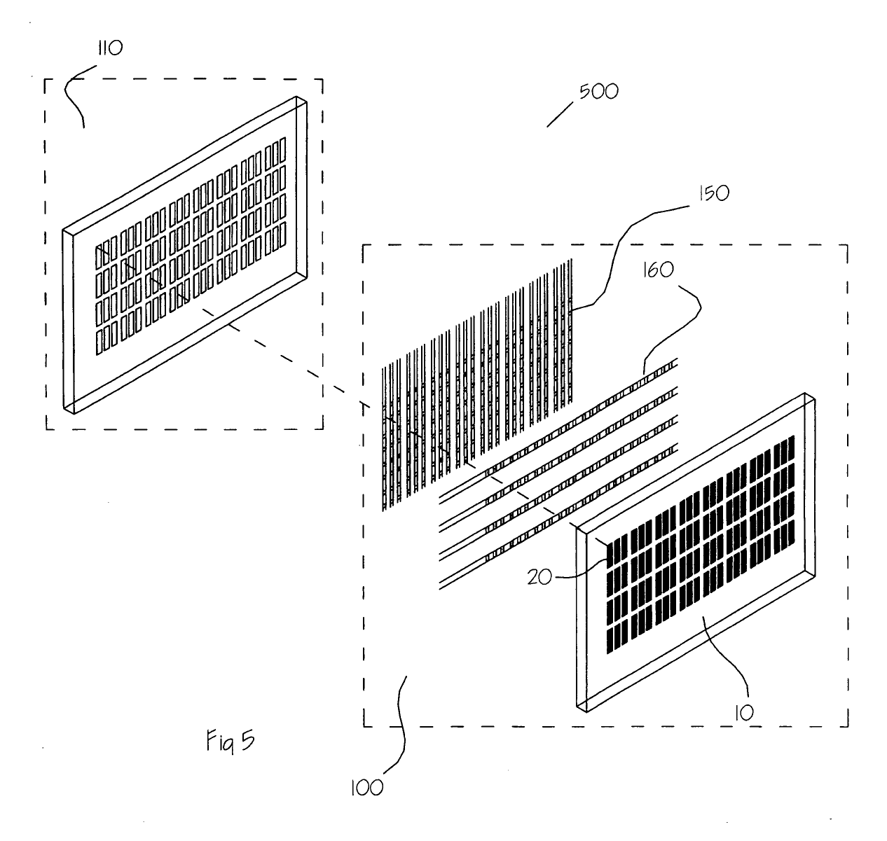

FIG. 5 is an illustration showing an embodiment of a display 500 having a touch screen function. Display 500 comprises the same display component 110 as in display 11, and a filter component 100 comprising two sensor arrays, a first sensor array 150 overlaid on a second sensor array 160. Sensor arrays 150 and 160 comprise the same passive ladder-like sensor structure as in passive display 400, but are at right angles with each other, so that sensor array 150 runs along the columns and are connected to the column control circuit 44, while sensor array 160 runs along the rows and are connected to row control circuit 46, or vise versa.

The touch screen embodiment shown in FIG. 5 can be used to update the pixels or subpixels 120 and record input data using a light pen or light-shadowing object. When light from a light pen strikes a particular point on a surface of the display 500, software or hardware in or associated with the column control circuit 44 should detect that at least one of the light sensors in at least one column in sensor array 150 has been exposed to the pen's light, while software or hardware in or associated with the row control circuit 46 should detect that at least one of the light sensors in at least one row in sensor array 160 has also been exposed to the pen's light. The information can be combined to determine the position at which the light strikes the surface of the display, which should be where the column(s) and the row(s) intersect. Therefore, as the light pen draws a line across the arrays 150 and 160, the arrays are repeatedly scanned and the sensors that were illuminated by the light pen identified.

Shadowing operates in a similar way. When a shadowing object points at a particular point on a surface of the display 500, software or hardware in or associated with the column control circuit 44 should detect that light emissions received by at least one of the light sensors in at least one column in sensor array 150 has been reduced because of the presence of the shadowing object, while software or hardware in or associated with the row control circuit 46 should detect that light emissions received by at least one of the light sensors in at least one column in sensor array 150 has been reduced because of the presence of the shadowing object. The information can be combined to determine the position at which the shadowing object points on the surface of the display, which should be where the column(s) and the row(s) intersect. In the usual case that the light from the light pen or shadow from the shadowing object runs across multiple rows and columns, known algorithms are available to precisely determine the position by locating the sensors affected most by the light pen or shadowing object.

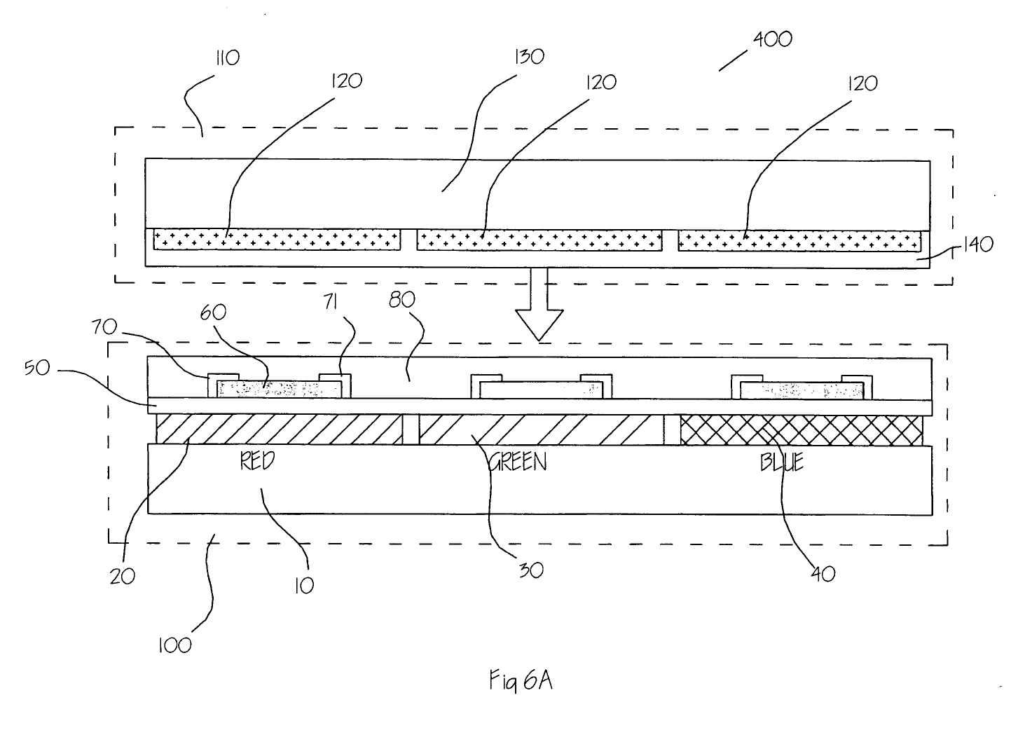

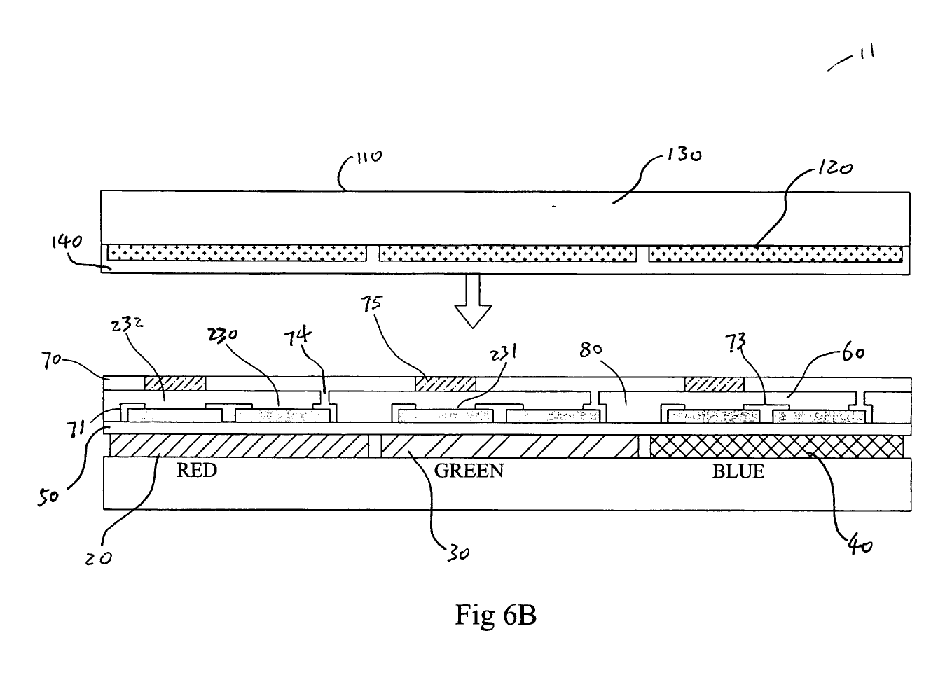

FIG. 6A illustrates a cross section of portions of the color filter component 100 and the display component 110 in passive display 400, according to one embodiment of the present invention. The arrow indicates that these two separate components are mated together during module construction to form the display 400. The display component 110 is shown to comprise three subpixels 120 associated with a pixel of the display. Subpixels 120 are formed over a substrate 130 and are covered by a transparent or substantially transparent protective layer 140. The color filter component 100 is shown to comprise three primary color filter elements 20, 30 and 40, formed on a color filter transparent substrate 10, and three sensors 60 formed over respective ones of the color filter elements 20, 30, and 40. A layer 50 of transparent material separates the color filter elements 20, 30, and 40 from the sensors 60. The color filter component 100 is also shown to comprise conductive lines 70 and 71 in contact with opposite sides of respective ones of the sensors 60, another layer 80 of transparent material covering the sensors 60 and conductive lines 70, 71.

Although FIG. 6A only shows three subpixels associated with one pixel. It is to be understood that there may be many such pixels is an array to form the complete display. For example, a VGA display has 640 columns of pixels and 480 rows. Each pixel has three colored subpixels. Not all of the color filter layers are shown, as the construction of color filters is well known in the art.

The color filter elements 20, 30, and 40 can be formed over the transparent substrate 10 using conventional techniques. Once the color filter elements are formed, layer 50 can be formed by depositing a layer of transparent dielectric material, such as silicon dioxide and silicon nitride, using methods such as chemical vapor deposition (CVD), plasma enhanced chemical vapor deposition (PECVD), radio frequency (RF) sputtering, or other semiconductor processing techniques well know in the art. Another possible transparent dielectric process would include the anodic oxidation of metal tantalum or other similar metals in the same group in the Periodic Table. A further possibility is the use of a transparent polyimide for dielectric 50.

The formation of dielectric layer 50 is followed by the deposition of a light-sensitive material over the dielectric layer 50. Suitable light sensitive materials include amorphous silicon, poly silicon, cadmium selenide, tellurium and many others. Techniques for depositing the light-sensitive material include PECVD, and sputtering, where sputtering is preferred. Once the light sensitive material is deposited it is patterned using typical photolithographic techniques will known in the art, and etched using plasma etching or other known techniques to form the individual sensors.

For passive display 400, conductive lines 70 and 71 can be formed by first forming a blanket layer of a metallic material, such as aluminum, using evaporation or sputtering, and then pattern and etch the metal layer to form the conductive lines. Good ohmic contact between conductive lines 70 and 71 and the sensors 60 is achieved using processes well known in the art. After conductive lines 70 and 71 are formed, a protective layer 80 is deposited using, for example, the same types of transparent dielectrics as were used for dielectric layer 50.

In the touch screen embodiment, a second sensor array may be formed over the transparent layer 80 by depositing and patterning another layer the light-sensitive material to form the sensors in the second sensor array and by forming and patterning another layer the metallic material to form the conductive lines in the second sensor array. The conductive lines in the second sensor array run orthogonal to the conductive lines 70 and 71 in the sensor array below.

FIG. 6B illustrates a cross section of portions of the color filter component 100 and the display component 110 in an active matrix display, according to one embodiment of the present invention. The display component 110 is shown to comprise three subpixels 120 associated with a pixel of the display. Subpixels 120 are formed over a substrate 130 and are covered by a transparent protective layer 140. The color filter component 100 is shown to comprise three primary color filter elements 20, 30, and 40 formed on a color filter transparent substrate 10, and three sensors 60 formed over respective ones of the color filter elements 20, 30, and 40. Each sensor 60 is shown to comprise an OS 230 and a TFT 232 serially coupled with each other by conductor 73. A layer 50 of transparent or substantially transparent material separates the color filter elements 20, 30, and 40 from the sensors 60. The color filter component 100 is also shown to comprise sensor column lines 71 each contacting one side of a row of TFT 232. A layer 80 of transparent material covers the sensors 60 and the sensor column lines 71.

The color filter component 100 for the active matrix display further comprises sensor row lines 70 formed over the layer 80 of transparent material. The sensor row lines 70 runs orthogonal to the sensor column lines 71 and are isolated from sensor column lines 71 by the layer 80 of transparent material. The color filter component 100 further comprises metal contacts 74 connecting one side of a row of OS 230 to a sensor row line 70, and conductive gates 75 for the TFTs 232. In one embodiment, conductive gates 75 are part of sensor row lines 70 and are formed using the same conductive material as sensor row lines 70. Sensor row lines 70 and gates 75 are covered by a protective layer (not shown) made of a transparent or substantially transparent material.

Again, although FIGS. 6A and 6B only shows three subpixels associated with one pixel. It is to be understood that there may be many such pixels is an array to form the complete display. Also, not all of the color filter layers are shown, as the construction of color filters is well known in the art. The invention is applicable to any type of color filters including but no limited to dye filters, refraction filters, optical resonance filters, and the like, and on any type of transparent substrate including glass, quartz, plastic, and the like.

The color filter elements 20, 30, and 40 can be formed over the transparent substrate 10 using conventional techniques. Once the color filter elements are formed, layer 50 can be formed by depositing a layer of transparent dielectric material, such as silicon dioxide and silicon nitride, using methods such as chemical vapor deposition (CVD), plasma enhanced chemical vapor deposition (PECVD), radio frequency (RF) sputtering, or other semiconductor processing techniques well know in the art. Another possible transparent dielectric process would include the anodic oxidation of metal tantalum or other similar metals in the same group in the Periodic Table of the elements. A further possibility is the use of a transparent polyimide for dielectric 50, as well as other materials.

Dielectric 50 is followed by the deposition of a light sensitive material for the OS 230. Suitable light sensitive materials include amorphous silicon, poly silicon, cadmium selenide, tellurium and many others. Techniques for depositing the light-sensitive material include CVD, PECVD, sputtering, and other well-known techniques. In one embodiment, OS 230 and TFT 232 use a same light-sensitive material. So, once the light sensitive material is deposited it is patterned using typical photolithographic techniques will known in the art, and etched using plasma etching or other known techniques to form the individual OSs 230 and the substrates 231 for the TFTs 232.

Conductive lines 71, conductors 73 between TFT 232 and OS 230, and bottom portions of contacts 74 can be formed by forming a first blanket layer of a metallic material, such as aluminum, using evaporation or sputtering, and then pattern and etch the first metal layer to form the conductive lines 71, conductors 73 between TFTs 232 and OSs 230, and bottom portions of contacts 74. Good ohmic contact between the metallic material and the light sensitive material is achieved using processes well known in the art. Afterwards, transparent layer 80 is deposited using, for example, the same types of transparent dielectrics as were used for dielectric layer 50. Thereafter, contact holes or trenches for the contacts 74 are formed in the transparent layer 80 using conventional techniques such as photolithography and plasma etching. Conductive lines 70 and gates 75 are formed over transparent layer 80 by forming a second blanket layer of a metallic material over transparent layer 80. The formation of the second metallic layer should also fill the contact holes or trenches to form the contacts 74. Afterwards, the conductive lines 70 and gates 75 are formed by patterning the second metallic layer, and a protective layer (not shown) can be formed to cover the conductive lines 70 and gates 75.

During display module integration display component 110 is aligned with color filter component 100 so that the subpixels are matched one for one with the sensors or color filter elements.

As one benefit of integrating the sensor array 22 with the color filter 9, as shown in FIGS. 6A and 6B, the location of the color filters, 20, 30 and 40 serve to block out ambient light coming from the bottom of substrate 10, thus, eliminating the need for metallic dark shields, and thus, saving cost.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A color filter for use in a display, comprising:
a plurality of color filter elements formed on a substrate and organized in groups, each color element in a group being associated with a different color; and
a first array of sensors aligned with the color filter elements and formed on the substrate.

2. The color filter of claim 1, wherein each sensor in the array of sensors comprises a TFT.

3. The color filter of claim 1, further comprising a first transparent layer covering the color filter elements.

4. The color filter of claim 3, wherein the first array of sensors is formed over the first transparent layer.

5. The color filter of claim 4, further comprising a first group of conductive lines formed over the first transparent layer and in contact with respective rows of sensors.

6. The color filter of claim 5, further comprising a second group of conductive lines formed over the first transparent layer and in contact with respective rows of sensors.

7. The color filter of claim 4, further comprising a second group of conductive lines in contact with respective columns of sensors, the second group of conductive lines being isolated from the first group of conductive lines by a second transparent layer.

8. The color filter of claim 1, wherein each sensor corresponds to a subpixel in the display and a color element.

9. The color filter of claim 1, further comprising a second array of sensors over the first array of sensors and aligned with the first array of sensors.

10. The color filter of claim 9, wherein the second array of sensors are interconnected by conductive lines running orthogonal to conductive lines interconnecting the first array of sensors.

11. The color filter of claim 1 wherein the substrate is glass, or quartz, or plastic.

12. The color filter of claim 1 wherein the sensor array comprises a light sensitive material.

13. The color filter of claim 12 wherein the light sensitive material is amorphous silicon, polysilicon, or cadmium selenide.

14. The color filter of claim 1 wherein the sensor array comprises optically sensitive resisters, optically sensitive diodes, or optically sensitive transistors.

15. The color filter of claim 1 wherein each sensor in the sensor array includes an isolation transistor.

16. The color filter of claim 13 wherein the isolation transistor comprises amorphous silicon, polysilicon, or cadmium selenide.

17. A method for fabricating a color filter integrated with a sensor array, comprising:
forming a plurality of color filter elements on a transparent substrates;
covering the plurality of color filter elements with a first layer of a transparent material;
forming a first array of sensors on the first layer of transparent material; and
forming on the first layer of transparent material a first group of conductive lines each connected to a row of sensors.

18. The method of claim 17, further comprising:
forming on the first layer of transparent material a second group of conductive lines each connected to a row of sensors.

19. The method of claim 17, further comprising:
covering the plurality of sensors and the first layer of transparent material with a second layer of a transparent material.

20. The method of claim 119, further comprising:
forming contacts aligned with the sensors in the second layer of transparent material.

21. The method of claim 19, further comprising:
forming on the second layer of transparent material a second group of conductive lines running in a direction orthogonal to the first group of conductive lines and aligned with the contacts.

22. The method of claim 19, further comprising:
forming on the second layer of transparent material gates of a plurality of TFTs each associated with a sensor.

23. The method of claim 19, further comprising:
forming on the second layer of transparent material a second array of sensors; and
forming on the second layer of transparent material a second group of conductive lines each connected to a column of sensors in the second array of sensors, the second group of conductive lines running orthogonal to the first group of conductive lines.

24. A display, comprising:
a display component comprising a plurality of subpixels organized in groups and formed on a first substrate, each subpixel in a group being associated with a different color; and
a filter component, comprising:
a plurality of color filter elements organized in groups and formed on a second substrate, each group of color filter elements corresponding to a respective group of subpixels in the display component, each color element in a group being associated with a different color; and
an array of sensors formed on the second substrate and aligned with the plurality of subpixels and with the plurality of color filter elements; and
wherein each sensor has an associated electrical parameter dependent on a level of light emissions received from a respective subpixel thereby an electrical feedback parameter or signal dependent on the received level of light emissions is used to control the luminance of the respective subpixel

25 . The display of claim 24, wherein the color filter component further comprises a first transparent layer formed on the second substrate and covering the color filter elements, and wherein the array of sensors is formed over the first transparent layer.

26. The display of claim 25, wherein the color filter component further comprises a first group of conductive lines formed over the first transparent layer and in contact with respective rows of sensors.

27. The display of claim 26, wherein the color filter component further comprises a second group of conductive lines in contact with respective columns of sensors, the second group of conductive lines being isolated from the first group of conductive lines by a second transparent layer.
